(19) United States
(12) Patent Application Publication
(10) Pub. No.: US 2020/0036065 A1
(43) Pub. Date: Jan. 30, 2020

(54) HIGH-POWER BATTERY PACK USING GRAPHITE MATERIAL FOR HEAT DISSIPATION

(71) Applicant: Michael Wang, Beijing (CN)

(72) Inventor: Michael Wang, Beijing (CN)

(21) Appl. No.: 16/043,535

(22) Filed: Jul. 24, 2018

(51) Int. Cl. H01M 10/653; H01M 10/613; H01M 10/6551; H01M 2/10; H01M 2/08

(52) U.S. Cl. CPC H01M 10/653; H01M 10/613; H01M 2/08; H01M 2/1016; H01M 10/6551

(57) ABSTRACT

A high-power battery pack is provided which uses a graphite material for heat dissipation. A thermally-conductive graphite material is bonded in the middle of two cells. One thermally-conductive graphite material is respectively bonded on both an outer side of a first cell and an outer side of a last cell of a battery pack. In the battery pack, all the bonded thermally-conductive graphite materials are in contact with an inner wall of a sealed housing of the battery pack. Therefore, heat that dissipates from the battery pack can be effectively transferred to the housing through the thermally-conductive graphite material that has a unique property of uniform heat dissipation in two-dimensional directions, so that the battery pack can be safely used between −40° C. and 400° C., and the effect of heat dissipation for the battery pack is ensured.

### TECHNICAL FIELD

The present invention relates to the field of electrochemical batteries, and, in particular, relates to a high-power battery pack using a graphite material.

### BACKGROUND

In present times, there are practical concerns about energy conservation, emission reduction, environmental protection, greenhouse gases, global warming, decreasing oil reserves, and high oil prices. For example, the industrialization of electric cars becomes especially urgent and necessary. However, the performance of an electric vehicle is restricted by the performance of a battery pack. The performance of a battery pack is closely related to the working temperature of the battery pack. Currently, electric car manufacturers usually use cold conditioned air from a carriage to implement heat dissipation and ventilation for a battery pack, to satisfy a use temperature requirement of the battery pack. However, inappropriate heat dissipation and ventilation of a battery may cause a great increase in the energy consumption of an entire car.

A lead-acid battery has relatively low specific energy, the battery has relatively poor activity, and the number of discharge cycles is relatively small. Batteries with high specific energy such as nickel-hydrogen power batteries and lithium batteries are increasingly used in electric cars. However, these two types of batteries require adequate heat dissipation and ventilation, and at the same time it is required that the battery is waterproof and dustproof. Batteries of electric cars have strong electricity. If heat dissipation and ventilation systems are inappropriately designed for batteries, in one aspect, waterproof and dustproof requirements of the batteries are not satisfied, resulting in damage to human body; and in another aspect, during charging and discharging, the batteries release harmful gases that enter a carriage to cause damage to human body. Therefore, heat dissipation of high-power battery packs for electric cars becomes a problem that urgently needs to be resolved.

Accordingly, it would be desirable to improve batteries and heat dissipation arrangements to address these and other drawbacks in the known art.

### SUMMARY

To overcome the foregoing deficiencies, the objective of the present invention is to provide a high-power battery pack using a graphite material for heat dissipation.

In one embodiment of the invention, a thermally-conductive graphite material is bonded in the middle of two cells. One thermally-conductive graphite material is respectively bonded on both an outer side of a first cell and an outer side of a last cell of a battery pack. In the battery pack, all the bonded thermally-conductive graphite materials are in contact with an inner wall of a sealed housing of the battery pack.

In one aspect, the sealed housing of the battery pack is a steel case or an iron case having desirable thermal conduction performance and use safety.

The advantages and technical effects achieved by the present invention are as follows. The thermally-conductive graphite material has light weight, so that the weight of a battery pack is effectively reduced. Excellent electrical performance and thermal performance are provided, so that the effect of heat dissipation for a battery pack is greatly improved, and the safety and service life of the battery pack are improved. Various shapes, sizes, and thicknesses can be easily obtained through cutting according to requirements, so that the flexibility of use is increased. The use temperature has a wide range, achieving safe use from −40° C. to 400° C. A sealed epoxy adhesive is provided on a single surface or on both surfaces, and tidiness is achieved without messy lubricating grease or adhesives. The chemical stability is desirable, and no corrosion occurs in a common use environment.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitutes a part of this specification, illustrate one or more embodiments of the invention and, together with the general description given above and the detailed description given below, explain the one or more embodiments of the invention.

FIG. 1 is a schematic perspective view of a battery pack according to one embodiment of the present invention.

FIG. 2 is a schematic perspective view of the battery pack of FIG. 1, with one side of a sealed housing removed to illustrate internal features thereof.

### DETAILED DESCRIPTION

The present invention provides a high-power battery pack using a graphite material for heat dissipation. Embodiments of the invention are illustrated below with reference to the accompanying drawings. The preferred embodiments described here are used only to describe and explain the present disclosure, but not to limit the present disclosure.

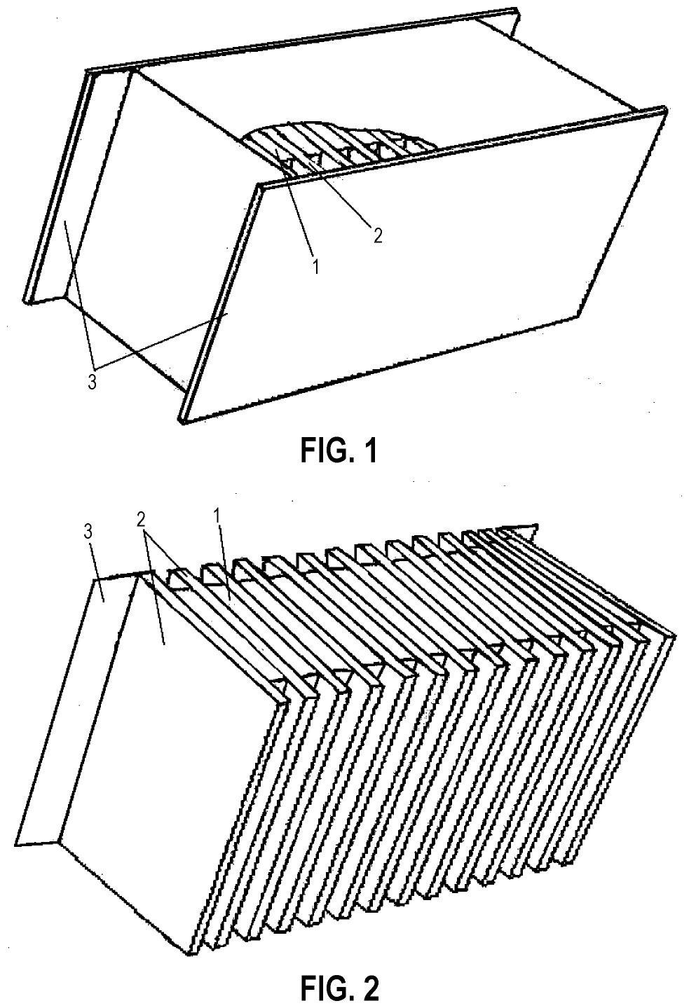

As shown in the embodiment of FIG. 1 and FIG. 2, a thermally-conductive graphite material 2 is bonded in the middle of two cells 1. One thermally-conductive graphite material 2 is respectively bonded on an outer side of a first cell and an outer side of a last cell of a battery pack. The thermally-conductive graphite materials 2 and the cells 1 are then placed in a sealed housing 3 of the battery pack. In the battery pack, all the bonded thermally-conductive graphite materials 2 are in contact with an inner wall of the sealed housing 3 of the battery pack, so that an ultra-low contact resistance is provided.

The foregoing battery pack is formed of 13 cells, 14 thermally-conductive graphite materials, and a sealed housing on two sides of the battery pack. During actual application, according to a specific use requirement, specific sizes and use quantities of the cells and the thermally-conductive graphite materials are not limited. A use quantity of the battery packs is not limited.

The thermally-conductive graphite material is prepared by performing special treatment on natural graphite, and keeps excellent electrical and thermal properties that are possessed by an anisotropic graphite material, a continuous graphite phase, and a unique property of uniform heat dissipation in two-dimensional directions, so that “thermal points” in a battery can be rapidly eliminated, so as to reduce a contact temperature in a third dimension and overcome the problem that a temperature field of an existing battery has relatively poor uniformity. Super electrical performance and thermal performance are provided as compared with fuel cell components made of synthetic graphite compounds and metals. Therefore, heat that dissipates from the battery pack can be effectively transferred to the housing through the thermally-conductive graphite material, so that the working temperature of a battery is controlled within an optimal range thereof. Temperature differences between modules of the battery pack are controlled below 5° C., to achieve the effect of heat dissipation for the battery pack. Therefore, the energy density of the battery is improved, and the safety and service life of the battery pack are greatly improved. Meanwhile, the thermally-conductive graphite material has a small weight and is 30% lighter than thermal conduction metal aluminum with a same size and 80% lighter than copper with a same size, so that the weight of a battery pack is effectively reduced and accordingly the weight of an entire car is reduced.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A high-power battery pack using a graphite material for heat dissipation, comprising:
a plurality of thermally-conductive graphite materials;
a plurality of cells; and
a sealed housing,
wherein one of the plurality of thermally-conductive graphite materials is bonded in the middle of any pair of two of the cells,
one of the plurality of thermally-conductive graphite materials is respectively bonded on both an outer side of a first cell and an outer side of a last cell of the plurality of cells in the battery pack, and
all the bonded thermally-conductive graphite materials are in contact with an inner wall of the sealed housing of the battery pack.

2. The high-power battery pack of claim 1, wherein the sealed housing of the battery pack includes at least one of a steel case and an iron case.

3. The high-power battery pack of claim 1, wherein the plurality of thermally-conductive graphite materials include 14 of the thermally-conductive graphite materials, and the plurality of cells include 13 of the cells.
